(19) United States
(12) Patent Application Publication
(10) Pub. No.: US 2010/0240462 A1
(43) Pub. Date: Sep. 23, 2010

(54) Screen rack structure for coin operating game machine

(76) Inventor: Hung-Ta Yeh, Xizhi City (TW)

Correspondence Address: Muncy, Geissler, Olds & Lowe, PLLC, 4000 Legato Road, Suite 310, FAIRFAX, VA, 22033, US

(21) Appl. No.: 11/979,946

(22) Filed: Nov. 9, 2007

(51) Int. Cl. A63F 13/08

(52) U.S. Cl. 463/46

(57) ABSTRACT

A screen rack structure for a coin operating game machine including two racks and a frame, wherein the two racks are separately fixed on a platform, each of these fixed racks has on an upper end of its front side a first guiding dent, and has on a lower end of the front side a second guiding dent, the pitch of the second guiding dent is larger than that of the first guiding dent, and the lower end of the front side has a stopping block behind the second guiding dent; the frame is for placing a screen thereon, the upper and the lower ends of its outer lateral sides are provided each with an upper engaging piece and a lower engaging piece respectively, so that the frame can be collapsed onto the racks firmly after all the engaging pieces are engaged in the first and the second guiding dents; when the upper engaging pieces get released from the first guiding dents, the lower engaging pieces are still engaged in the second guiding dents, thereby the frame can be pulled out of the racks taking the lower engaging pieces as fulcrums, until the bottom of the frame is abutted on the stopping blocks and stop.

### BACKGROUND OF THE INVENTION

1. Field of the Invention

The present invention relates to a screen rack structure for a coin operating game machine, and more particularly to a screen rack structure being designed to allow racks to be stretched and retracted for the convenience of electric line examination and maintenance for the coin operating game machine behind the screen; the screen rack structure is structurally simple, convenient for assembling, and suitable to apply to various coin operating game machine having LCD display screens.

2. Description of the Prior Art

Owing to a violent competition in the modern business world, many people are afflicted with more and more pressures. In order to keep both body and spirit in balance, various activities for leisure coin operating equipment have been provided accordingly; for instance, sporting, fishing vending machine, game machine in calligraphy, painting, and enjoying movies etc. Among the various activities (for leisure time) at the game business, game machines can directly provide physical and sensory stimulation to let off personal emotions, and people can get satisfaction by material and spiritual inspirations, hence game machines are main amusement tools for quite a lot of people.

The main structural design for conventional coin operating game machine renders images to be displayed on screens after treatment using elaborately designed electric circuits to provide the function of mutual communication of the machines with users; hence when the coin operating game machine are under routine examination and maintenance, screens always must be removed or taken down to examine the electric lines provided on the rear of the screens.

Although screens of conventional coin operating game machine in the recent years have been changed to lighter liquid crystal displays, workers still should pay attention in detaching display screens to avoid the display screens from being damaged or scraped; and after examination and maintenance, the screens must be remounted, in this view, the structural design in the positions of screens is much inconvenient for the workers and time wasting.

### SUMMARY OF THE INVENTION

The primary object of the present invention is to provide a screen rack structure for a coin operating game machine which is structurally simple, convenient for maintaining and repairing the electric lines of the coin operating game machine, and which can reduce working hours of maintaining.

To achieve the above object, the screen rack structure for a coin operating game machine provided in the present invention includes two fixed racks and one frame, wherein the two fixed racks are separately fixed on a platform of the coin operating game machine, each of these fixed racks has on an upper end of its front side juxtaposed to its outer lateral side a first guiding dent, and has on a lower end of the front side a second guiding dent, the pitch of the second guiding dent is larger than that of the first guiding dent, and the lower end of the front side juxtaposed to the outer lateral side has a stopping block behind the second guiding dent; the frame is for placing a screen thereon, the upper end and the lower end of each of the two outer later sides of the frame are provided with an upper engaging piece and a lower engaging piece respectively, so that the frame can be collapsed onto the fixed racks firmly after the upper and the lower engaging pieces are engaged in the first and the second guiding dents; when the upper engaging pieces get released from the first guiding dents, the lower engaging pieces are still engaged in the second guiding dents, thereby the frame can be pulled out of the fixed racks taking the lower engaging pieces as fulcrums, until the bottom of the frame is abutted on the abovementioned stopping blocks and stop.

The present invention will be more apparent after reading the detailed description of the preferred embodiment thereof in reference to the accompanying drawings.

### BRIEF DESCRIPTION OF THE DRAWINGS

FIG. 1 is an anatomic perspective view showing the appearance of an embodiment of the present invention before assembling its two fixed racks and one frame;

FIG. 2 is a perspective view showing the appearance of the embodiment of the present invention after assembling the two fixed racks and the frame;

FIG. 3 is a schematic view showing a state of use of the embodiment of the present invention in which the frame is pulled out of the frame;

FIG. 4 is a perspective view showing the appearance of the embodiment of the present invention when it is mounted onto a platform of a game machine.

### DETAILED DESCRIPTION OF THE PREFERRED EMBODIMENT

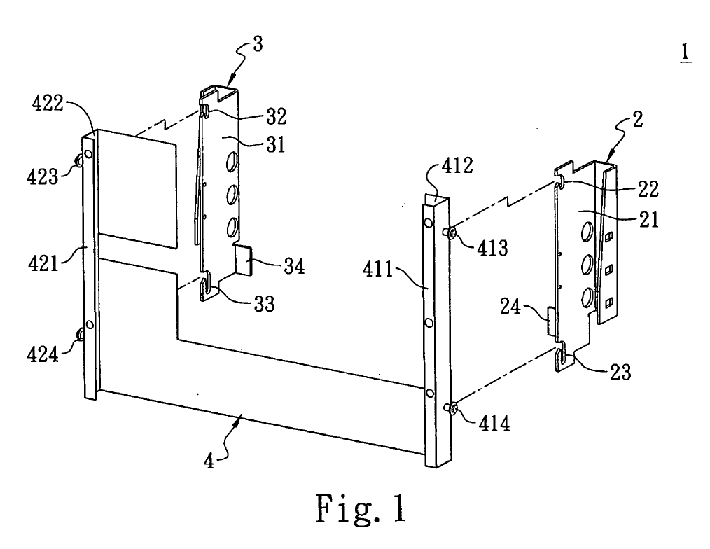

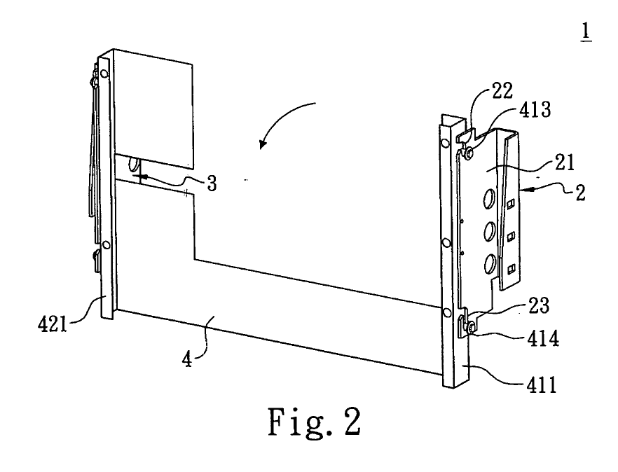

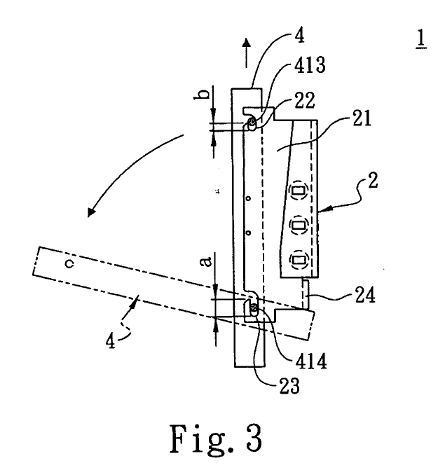

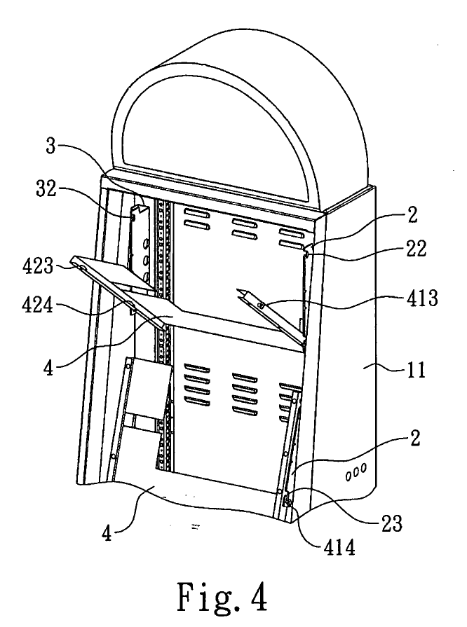

Referring to FIGS. 1-4 which show an embodiment of a screen rack structure 1 for a game machine of the present invention, the screen rack structure 1 is composed of two fixed racks 2, 3 and one frame 4.

The two fixed racks 2, 3 are separately fixed on a platform 11 of the coin operating game machine, and the fixed racks 2, 3 form there between a distance after being fixed, the fixed racks 2, 3 each has on its upper end of a front side juxtaposed to its outer lateral side 21 (31) a first guiding dent 22 (32), and has on its lower end of the front side a second guiding dent 23 (33), the pitch “a” of the second guiding dent 23 (33) is larger than the pitch “b” of the first guiding dent 22 (32), and the lower end of the front side juxtaposed to the outer lateral side 21 (31) has a stopping block 24 (34) behind the second guiding dent.

The frame 4 is provided on its two outer later sides 41, 42 each with a folded side 411 (412) respectively to form channels 412, 422 for placing a screen (such as a liquid crystal display) thereon, the upper end and the lower end of each of the outer later sides 41, 42 of the frame 4 is provided with an upper engaging piece 413 (423) and a lower engaging piece 414 (424) respectively, so that the frame 4 can be collapsed onto the fixed racks 2, 3 firmly after the upper and the lower engaging pieces 413, 423, 414 and 424 are engaged in the first and the second guiding dents 22, 32, 23 and 33.

Hence when in practicing, as shown in FIGS. 1-4, when the two fixed racks 2, 3 are separately fixed on the platform 11 of the coin operating game machine, the upper and the lower engaging pieces 413, 423, 414 and 424 of the frame 4 are engaged respectively in the first and the second guiding dents 22, 32, 23 and 33 of the fixed racks 2, 3, so that the frame 4 can be engaged in the fixed racks 2, 3. Thereby, in maintaining and repairing, when workers brace up the frame 4, the upper engaging pieces 413, 423 get released from the first guiding dents 22, 32, thereby the frame 4 can be pulled out; however, by virtue that the pitch “a” of the second guiding dent 23 (33) is larger than the pitch “b” of the first guiding dent 22 (32), thereby notwithstanding that the upper engaging pieces 413, 423 get released from the first guiding dents 22, 32 when workers brace up the frame 4, the lower engaging pieces 414, 424 are still received in the second guiding dents 23, 33, and thereby the bottom of the frame 4 is still engaged in the second guiding dents 2, 3 without releasing completely; and when the frame 4 is stretched away for an angular distance, the lower engaging pieces 414, 424 on the frame 4 form the action of fulcrums, the top of the frame 4 can be displaced downwards, while the bottom of the frame 4 can be displaced upwards until the top of the frame 4 abuts against the stopping blocks 24, 34 to stop the frame 4 from being further stretched away.

Therefore, the workers for maintaining and repairing can do their work for the electric lines of coin operating game machine behind the screen, there is no need to detach the connecting structure of the screen before examination and repairing as is done in the way for the conventional structure; and the design of abutting action between the bottom of the frame and the stopping blocks can brace the stretched away frame in due time, thereby after examination and repairing, the workers only need to push the top of the frame toward the fixed racks to easily collapse the frame onto the fixed racks.

The embodiment stated above is only for illustrating the present invention, it will be apparent to those skilled in this art that various equivalent modifications or changes according to the idea of and without departing from the spirit of this invention shall also fall within the scope of the appended claims.

1. A screen rack structure for a coin operating game machine, said coin operating game machine is mounted on a platform and comprises:
two fixed racks separately fixed on said platform of said coin operating game machine, and said fixed racks form there between a distance after being fixed, said fixed racks each has on its upper end of a front side juxtaposed to its outer lateral side a first guiding dent, and has on its lower end of said front side a second guiding dent, a pitch of said second guiding dent is larger than a pitch of said first guiding dent, and a lower end of said front side juxtaposed to said outer later sides has a stopping block behind said second guiding dent; and
a frame for placing of said screen thereon, an upper end and a lower end of each of two outer later sides of said frame are provided with an upper engaging piece and a lower engaging piece respectively, so that said frame is adapted to being collapsed onto said fixed racks firmly after said upper and said lower engaging pieces are engaged in said first and said second guiding dents; when said upper engaging pieces get released from said first guiding dents, said lower engaging pieces are still engaged in said second guiding dents, thereby said frame is adapted to being pulled out of said fixed racks taking said lower engaging pieces as fulcrums, until a bottom of said frame is abutted on said stopping blocks and stop.

2. The screen rack structure for a coin operating game machine as defined in claim 1, wherein said frame is provided on its said two outer lateral sides each with a folded side respectively to form channels for placing a screen thereon.

3. The screen rack structure for a coin operating game machine as defined in claim 1, wherein said screen is a liquid crystal display.
